(19) United States
(12) Patent Application Publication
(10) Pub. No.: US 2015/0334277 A1
(43) Pub. Date: Nov. 19, 2015

(54) MEMS BASED DUST REMOVAL FOR IMAGE SENSORS

(71) Applicant: MEMS DRIVE, INC., Arcadia, CA (US)

(72) Inventors: XIAOLEI LIU, South Pasadena, CA (US); ROMAN GUTIERREZ, Arcadia, CA (US)

(73) Assignee: MEMS DRIVE, INC., Arcadia, CA (US)

(21) Appl. No.: 14/631,782

(22) Filed: Feb. 25, 2015

Related U.S. Application Data
(60) Provisional application No. 61/992,758, filed on May 13, 2014.

(51) Int. Cl. H04N 5/225; G02B 27/00

(52) U.S. Cl. CPC H04N 5/2253; G02B 27/0006; H04N 5/2257

(57) ABSTRACT

Systems and methods provide dust removal on an image sensor surface of a digital camera. Dust removal can be achieved by either imparting vibrational movement on a stage upon which the image sensor is mounted and/or by moving the stage towards one or more impact stops. The vibrational movement may shake loose any contaminants present on the image sensor. The impact of the stage at the one or more impact stops also may shake loose any contaminants present on the image sensor.

### CROSS-REFERENCE TO RELATED APPLICATIONS

This application claims the benefit of U.S. Provisional Patent Application Ser. No. 61/992,758 filed May 13, 2014, which is incorporated herein by reference in its entirety.

### TECHNICAL FIELD

The present disclosure generally relates to an image sensing device/sensor mounted on a microelectromechanical (MEMS) stage. More particularly, various embodiments of the technology described herein are directed to systems and methods for removing dust from an image sensor.

### BACKGROUND

The use of digital cameras has become ubiquitous due to their ease of use and convenience. Furthermore, the integration of digital camera technologies into mobile devices such as cellular phones, smart phones, personal digital assistants (PDAs), tablet computers, and the like has made their use even more commonplace due to the proliferation of mobile device usage. Additionally still, smart phones having digital cameras implemented therein (camera phones) enable images to be conveniently and rapidly shared with others. For example, images can be captured at the spur of the moment, and then easily communicated to others via a cellular communications network and/or the Internet.

Digital cameras, whether implemented as stand-alone cameras or as camera phones, still suffer from the problem of foreign substances, such as dust and other particulate matter, falling onto or coming to rest on the image sensor of the digital camera thereby contaminating the image sensor. This can occur during the digital camera manufacturing process and/or during use of the digital camera. Such dust or particulate matter can result in, e.g., dark spots of different sizes appearing as part of the image(s) taken with a contaminated image sensor. Although image post-processing software may be utilized to remove these spots from an image, overall image quality and image processing time can be compromised (as arriving at an acceptable image would require additional steps and time).

### SUMMARY

In accordance with one embodiment, a device comprises a component sensitive to contaminants. The device further comprises a stage upon which the image sensor is mounted. Further still, the device comprises one or more actuators for imparting movement on the stage to remove one or more contaminants residing on the image sensor.

In accordance with another embodiment, a method comprises inducing movement of a contaminant-sensitive component for at least one of a specified duration and a specified number of movements for removing one or more contaminants are present on the contaminant-sensitive component. The method further comprises, ceasing inducing the movement of the contaminant-sensitive component upon reaching the at least one of the specified duration and the specified number of movements.

In accordance with still another embodiment, a camera system comprises an image sensor, and a microelectromechanical (MEMS) stage on which the image sensor is mounted, the MEMS stage engaging in movement to remove one or more contaminants present on the image sensor.

Other features and aspects of the disclosure will become apparent from the following detailed description, taken in conjunction with the accompanying drawings, which illustrate, by way of example, the features in accordance with various embodiments. The summary is not intended to limit the scope of the disclosure, which is defined solely by the claims attached hereto.

### BRIEF DESCRIPTION OF THE DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1 is a planar view of an example contaminated image sensor mounted on a MEMS stage.

FIGS. 2A and 2B illustrate an example of in-plane vibration dust removal on the image sensor of FIG. 1 in accordance with various embodiments of the technology disclosed herein.

FIGS. 3A, 3B, and 3C illustrate an example of impact dust removal on the image sensor of FIG. 1 in accordance with various embodiments of the technology disclosed herein.

FIG. 4 is an operational flow chart illustrating example processes performed for dust removal using vibration in accordance with one embodiment of the technology disclosed herein.

FIG. 5 is an operational flow chart illustrating example processes performed for dust removal using impact in accordance with another embodiment of the technology disclosed herein.

FIG. 6 is a schematic representation of an example image sensor employing dust removal in accordance with various embodiments of the technology disclosed herein.

FIG. 7A is a perspective view of an example mobile device employing dust removal in accordance with various embodiments of the technology disclosed herein.

FIG. 7B is a perspective view of an example camera module employing dust removal in accordance with various embodiments of the technology disclosed herein.

FIG. 7C is a perspective view of an example packaged image sensor employing dust removal in accordance with various embodiments of the technology disclosed herein.

FIG. 7D is cross-sectional view of the example packaged image sensor employing dust removal of FIG. 7C.

FIG. 8 illustrates an example chip set that can be utilized in implementing architectures and methods for controlling dust removal in accordance with various embodiments of the technology disclosed herein.

The figures are not intended to be exhaustive or to limit the various embodiments to the precise form disclosed. It should be understood that technology disclosed herein can be practiced with modification and alteration, and that the disclosed technology be limited only by the claims and the equivalents thereof.

### DETAILED DESCRIPTION

As alluded to above, the contamination of an image sensor or processor due to dust or other particulate matter (whether solid or liquid, e.g., condensation that may form on the image sensor) can foul captured images. Hence, it is desirable to keep the surface of an image sensor as pristine and as free from any contamination as possible.

Theoretically, to achieve, e.g., a dust-free image sensor, the image sensor would have to be assembled in a camera device and utilized in a dust free environment. However, a particle-free environment is not realistically achievable, even when assembling the camera in a “clean room” environment. As a result, an on-board dust removal mechanism and method should be utilized to clean the image sensor surface when it is contaminated by dust, particles, condensation, etc.

Some digital cameras with interchangeable lenses (e.g., digital single lens reflex (DSLR) cameras) are equipped with a dust removal feature to shake any dust from a window/mirror that covers the image sensor by driving or actuating the window/mirror surface to move either in-plane or out-of-plane using, e.g., sinusoidal signals. However, such systems are merely designed to remove particles from the surface of the window/mirror, but not particles that may actually come to rest on the surface of the image sensor itself. In addition, the power consumption, size, and cost associated with such dust removal mechanisms prohibits their implementation in miniature digital cameras that are widely used in mobile devices such as cellular phones, smart phones, tablets, and other portable electronic devices.

Accordingly, various embodiments of the technology disclosed herein provide systems and methods directed to MEMS based dust or other contaminant removal which may be used in, for example, but not limited to, portable electronic devices, miniature cameras, optical telecommunications components, and medical instruments.

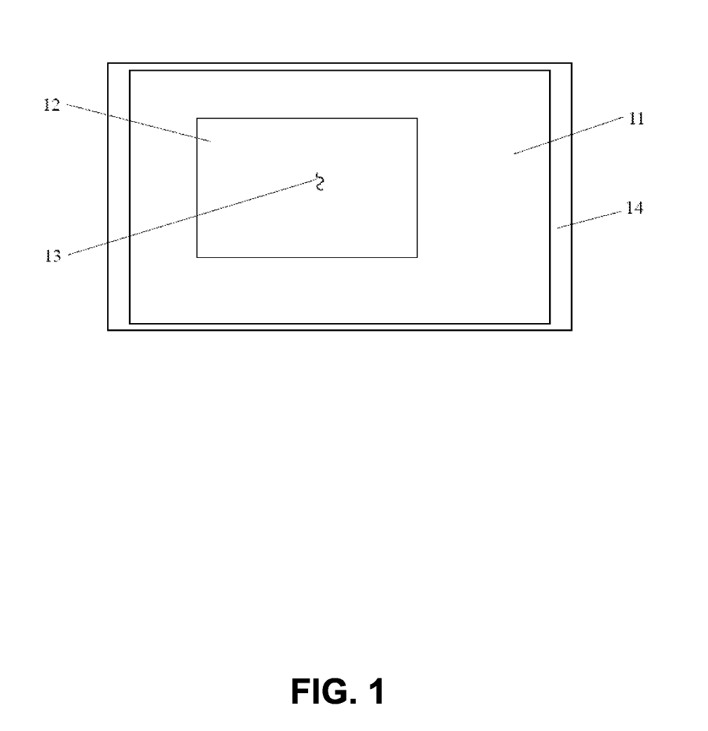

FIG. 1 illustrates a planar view of an example image sensor 11, which is mounted on a MEMS stage 14, where MEMS stage 14 can provide for precise motion control. Image sensor 11 may be any appropriate imaging sensor package, and MEMS stage 14 may be any appropriate stage in which movement can be induced, such as a stage including one or more movable elements and/or flexures, MEMS actuators, etc. Some examples of MEMS actuators suitable for moving an image sensor are described in U.S. Application Ser. No. 61/975,617 which is incorporated herein by reference in its entirety. As described above, particulate matter such as dust, condensation, etc. can come into contact with image sensor 11. For example, and as illustrated in FIG. 1, a contaminant, e.g., dust particle 13, is shown as being stuck on pixel array area 12 of image sensor 11. Dust particle 13 may have come to rest on pixel array area 12 during the camera manufacturing process and/or during user handling of the apparatus (e.g., portable device) in which the camera is placed. Dust particle 13 may cause a dark spot on an image(s) taken by the camera in which image sensor 11 is implemented.

Due to the placement or mounting of image sensor 11 onto MEMS stage 14 (which can provide some actuation force and hence, motion in a desired or controlled manner), image sensor 11 can be made to move as a result of and/or commensurate with the movement of MEMS stage 14. Due to the movement of MEMS stage 14 and the resulting movement of image sensor 11, dust particle 13 can be shaken off of pixel array area 12.

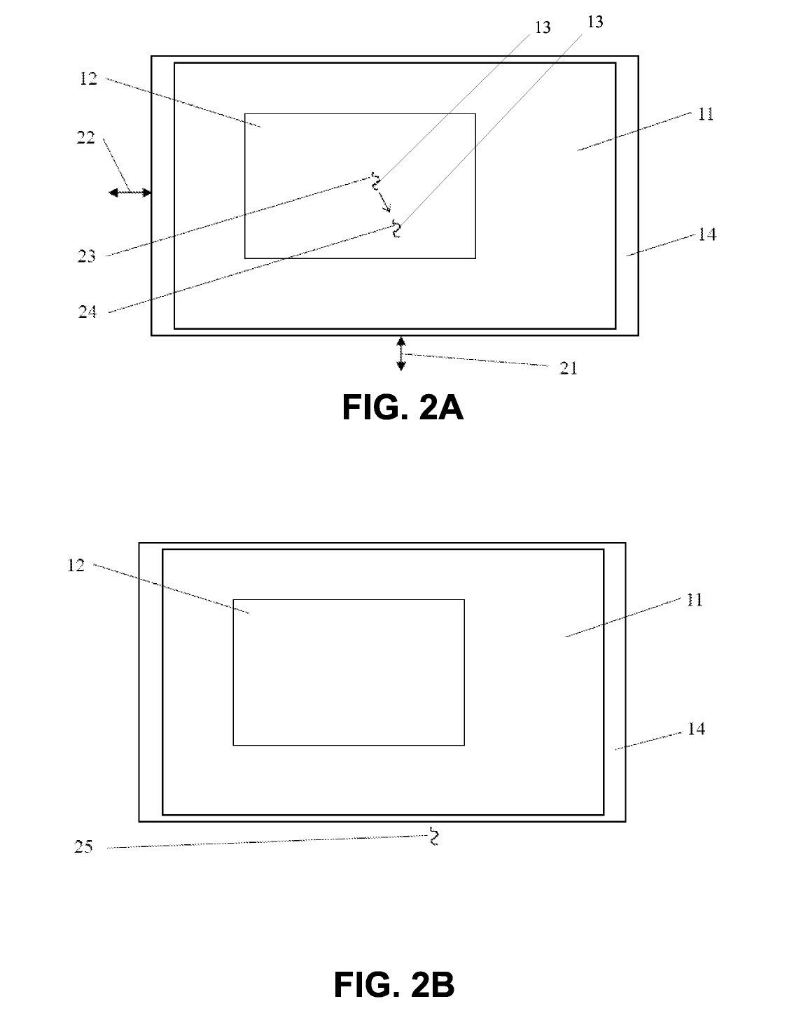

FIG. 2A illustrates such movement in the form of controlled vibration, and FIG. 2B illustrates the removal of dust particle 13 in accordance with one embodiment of the technology disclosed herein. In particular, FIG. 2A illustrates how image sensor 11 can be driven by MEMS stage 14 and vibrated in-plane to effectuate dust removal by shaking dust particle 13 that is stuck on pixel array area 12 loose and move from its original location 23 to a new location 24. As utilized herein, the term “in-plane” vibration can refer to movement in one or more directions commensurate with the planar surface of MEMS stage 14/image sensor 11. That is, the vibrational motion can be in a vertical direction 21 or in a horizontal direction 22, or in both directions.

Moreover, the vibrational motion can be effectuated in accordance with, but not limited to, a random vibration mode, a sinusoidal mode, etc. In the case of sinusoidal vibrational movement (in which MEMS stage 14 can move around some equilibrium position in a periodic/smooth manner) the maximum force on dust particle 13 can be proportional to its mass, the amplitude of the motion, and quadratically proportional to the frequency of the vibration. As further illustrated in FIG. 2A, dust particle 13, which may have originally been stuck to pixel array area 12 at a first location or position 23 can be shaken loose or forced to move as a result of the vibrational motion such that it moves to a second location or position 24, and so on until it moves or is shaken completely off pixel array area 12 and/or image sensor 11. FIG. 2B illustrates that after some certain time in which vibrational motion is applied to image sensor 11 via MEMS stage 14, dust particle 13 can be shaken off pixel array area 12 and/or off the image sensor 11 and move to a location 25 that will no longer affect image quality. In other words, a dark spot resulting from dust particle 13 will cease to appear in images processed by image sensor 11.

It should be noted that the amount of time that vibrational motion is applied to image sensor 11 can be controlled in any number of ways. For example, predetermined lengths of time during which vibrational motion is applied can be configured a controller or microprocessor of the camera in which image sensor 11 is implemented. Alternatively, or in addition to predetermined times, the camera can be configured to periodically or aperiodically take test/sample images to determine if one or more dark spots (that may be attributed to contaminating particulate matter) appear. If such dark spots occur in the resulting test/sample images, the camera can be configured to induce vibrational motion until no dark spots remain in the resulting test/sample images. Various algorithms can be used to effectuate the inducement of vibrational motion in accordance with various embodiments. It should be further noted that the vibrational dust removal process can be initiated automatically, e.g. upon sensing the presence of a contaminant, periodically, or it may be initiated by a user upon the user noticing the presence of dark spots on images that may be the result of dust being present on image sensor 11, or upon startup of the camera in which image sensor 11 is implemented.

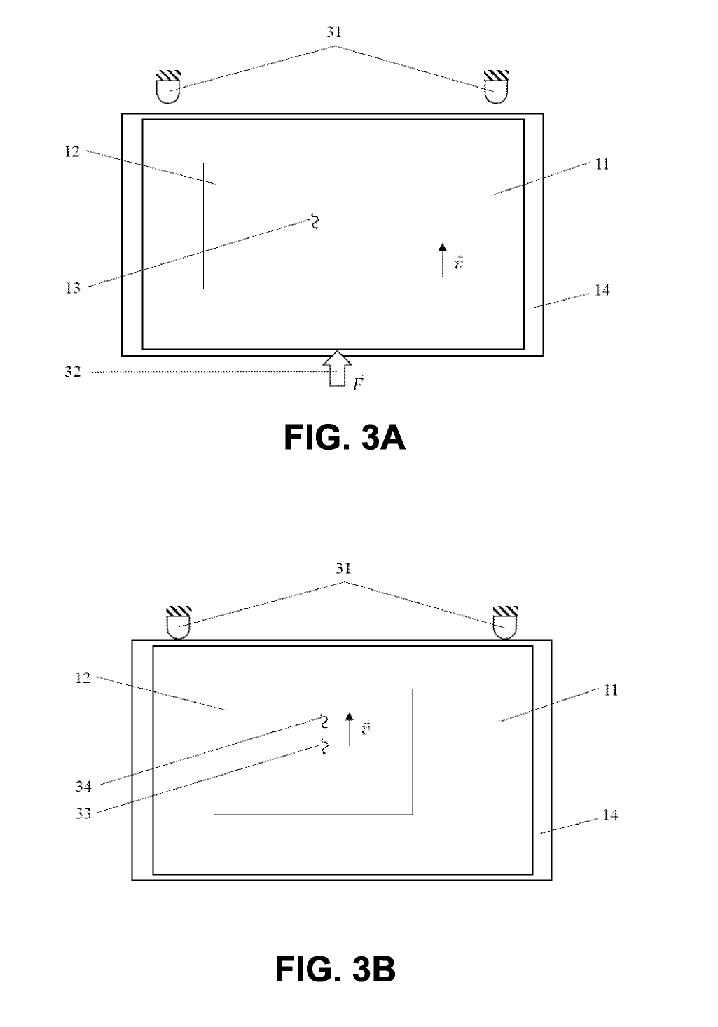

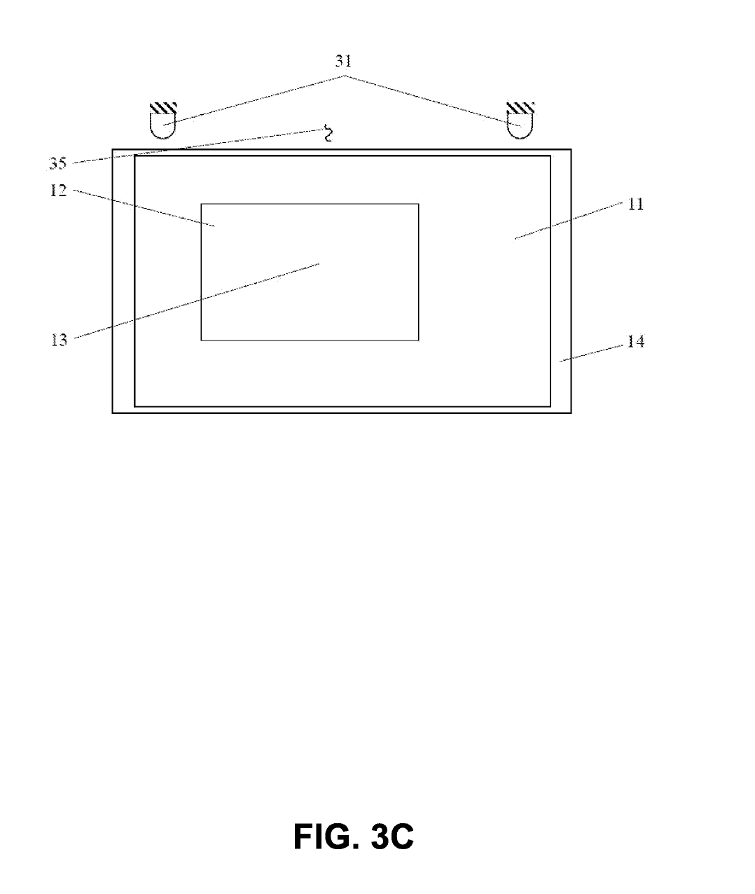

FIGS. 3A, 3B, and 3C illustrate planar views of image sensor 11 mounted on MEMS stage 14, dust particle 13 which is stuck on pixel array area 12, and the stages of an impact contaminant removal process in accordance with another embodiment of the technology disclosed herein. In particular, FIG. 3A illustrates image sensor 11 having a contaminant, e.g., dust particle 13, on the pixel array area 12. In accordance with this embodiment, image sensor 11 can be accelerated (acceleration being the change in velocity (v) over the change in time) towards bumpers 31 by MEMS stage 14 which provides an actuation force (F) 32. It should be noted that although the use of bumpers are illustrated and described herein, any stop mechanism/element in order to abruptly stop movement of image sensor 11 such that dust particle 13 is shaken loose may be utilized. Moreover, although two bumpers 31 are illustrated, a single bumper may be used, or more than two bumpers may be used.

That is, FIG. 3B illustrates that when image sensor 11 and/or MEMS stage 14 hit bumpers 31 subsequent to having an accelerative force applied thereto, it/they may stop with enough deceleration such that the shock of the impact may shake dust particle 13 from its original location 33 and continue moving in the same direction (or another direction) to a new location 34. The force on dust particle 13 during or substantially subsequent to the time of impact can be much higher than that experienced in the above-described embodiment where vibrational motion is utilized. Accordingly, use of impact dust removal may be used, for example, after unsuccessful attempts to remove dust using vibrational motion have been tried, or simply as an alternative thereto, as the greater force may have a better chance of dislodging dust particle 13 from image sensor 11 so that it may move out of pixel array area 12.

FIG. 3C illustrates image sensor 11 and/or MEMS stage 14 in a state subsequent to impact, where image sensor 11 and/or MEMS stage 14 no longer contact bumpers 31. In particular, and after the impact, dust particle 13 is illustrated as having moved off of pixel array area 12, or even off image sensor 11 and/or MEMS stage 14 entirely. Thus, dust particle 13 has moved to a location 35 that will not affect the image quality of any images subsequently captured or processed by image sensor 11.

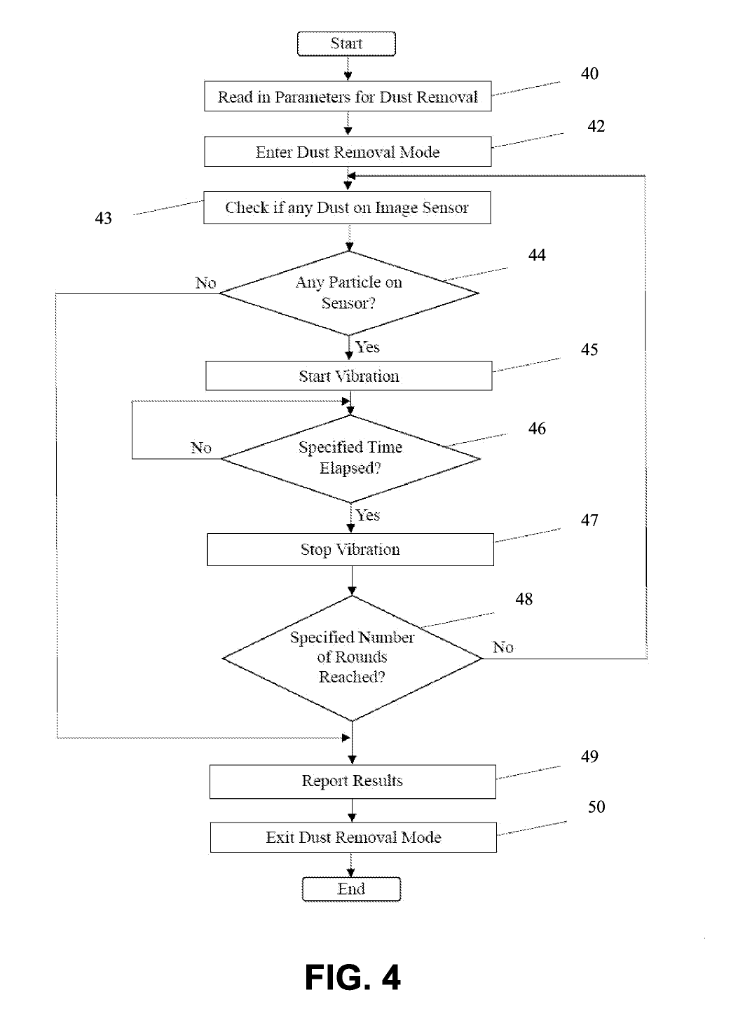

FIG. 4 is an operational flow chart illustrating example processes that can be performed in accordance with one embodiment of the technology disclosed herein to perform vibration dust removal. When a user or camera system determines that contaminant removal is necessary, the example processes can be started. For example, this process may be automatically triggered every time the camera is turned on, when the phone is turned on, on a periodic time basis, by user command, or when a particle is detected using an appropriate detection method/system. At operation 40, parameters for dust removal (stored in a memory device) are read in. Such parameters may involve the type of vibrational motion to be utilized, e.g., sinusoidal vibration, the intensity of the vibration to be utilized, the direction(s) in which the image sensor and/or MEMS stage are to be vibrated, etc.

Upon reading in of the parameters, the parameters can be loaded as the camera system enters dust removal mode at operation 42. At operation 43, the camera system may check to determine if dust or any other contaminant is present on the image sensor. In particular, an image may be captured and analyzed to determine if any dust particle(s) are found (e.g., by the presence of any dark spots that would be anomalous in a “clean” image). For example, one or more algorithms may be utilized to, e.g., perform an analysis of neighboring pixels to determine whether or not a “dark spot” on a resulting image is part of the scene that is captured in the resulting image or one that is potentially the result of a contaminant present on the image sensor. Depending on the analysis, at operation 44, if no contaminant is found on a sensitive area of the image sensor (e.g., pixel array area), i.e., the pixel array area is clean and no dust removal is necessary, the dust removal process need not progress further. In accordance with some embodiments, this result can be reported at operation 49. The camera system may then exit the dust removal mode at operation 50 and end the dust removal process.

On the other hand, and if a particle is detected or if the particle detection portion of the process was skipped, a control signal can be sent to the MEMS stage in order to begin vibrating the image sensor at operation 45 for some specified amount of time. As discussed previously, the duration of the vibration that is applied to the MEMS stage/image sensor can be variable and may be controlled. At operation 46, it can be determined whether or not the specified amount of time during which vibration is to occur has elapsed. If so, at operation 47, the vibration is stopped. In accordance with some embodiments, there may be a certain number of rounds of such vibrations that are induced. In this case, at operation 48, it is determined if the specified number of rounds of vibration have been reached. Like the duration of vibration, the number of rounds of vibration can be varied/controlled as desired or as necessary. For example, there can be some set number of rounds. It should be noted that the intensity of vibration can also be varied and/or controlled if desired. For example, if after some threshold number of vibratory actions has been applied and the particle remains, stronger vibrations may be induced. Alternatively, checking for the presence of dust (at operation 43) can be repeated until no dust is found. If the specified number of vibration rounds has not yet been reached, another round of vibrational motion is initiated. If the specified number of rounds has been reached, the process can report the results at operation 49, and the camera system can exit the dust removal mode at operation 50, thereby ending the dust removal process.

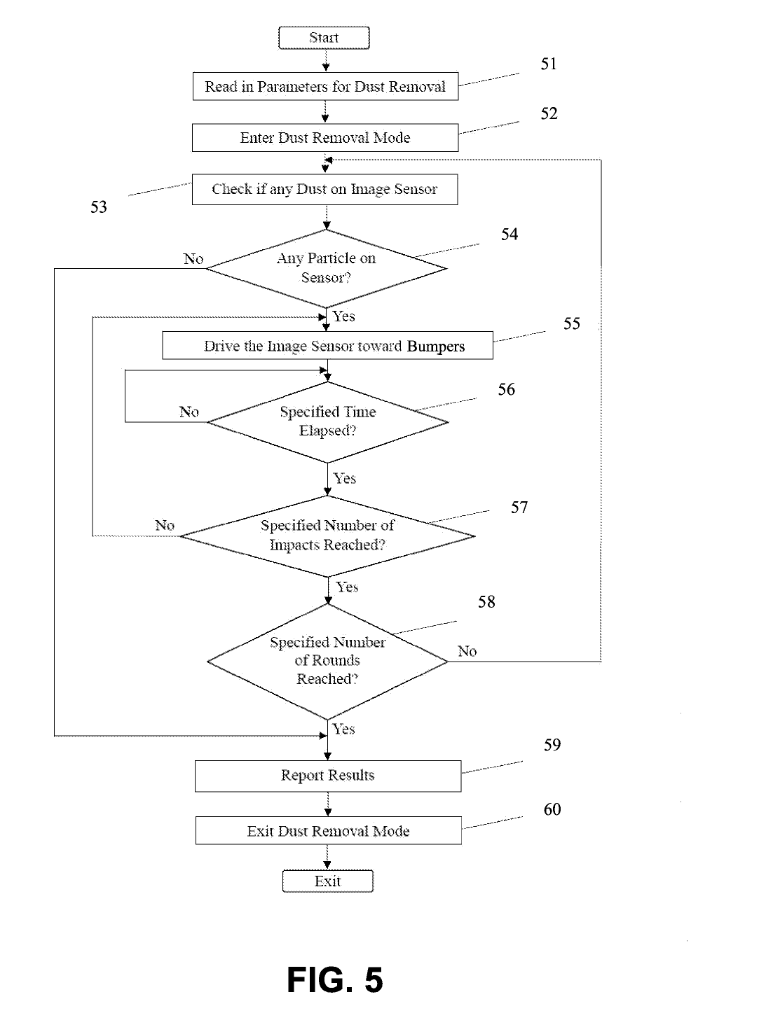

FIG. 5 is an operational flow chart illustrating example processes that can be performed in accordance with another embodiment of the technology disclosed herein to perform impact dust removal. As described above with regard to the example processes illustrated in FIG. 4, if a user or camera system determines that contaminant removal is necessary, the example processes can be started. For example, this process may be automatically triggered every time the camera is turned on, when the phone is turned on, on a periodic time basis, by user command, or when a particle is detected using an appropriate detection method/system. At operation 51, parameters for dust removal (stored in a memory device) are read in. Such parameters may involve the velocity at which the MEMS stage is to be moved towards a bumper, the direction(s) in which the image sensor and/or MEMS stage are to be accelerated, etc.

Upon reading in of the parameters, the parameters can be loaded as the camera system enters dust removal mode at operation 52. At operation 53, the camera system may check to determine if dust or any other contaminant is present on the image sensor. In particular, an image may be captured and analyzed to determine if any dust particle(s) are found (e.g., by the presence of any dark spots that would be anomalous in a “clean” image).). For example, one or more algorithms may be utilized to, e.g., perform an analysis of neighboring pixels to determine whether or not a “dark spot” on a resulting image is part of the scene that is captured in the resulting image or one that is potentially the result of a contaminant present on the image sensor. Depending on the analysis, at operation 54, if no contaminant is found on a sensitive area of the image sensor (e.g., pixel array area), i.e., the pixel array area is clean and no dust removal is necessary, the dust removal process need not progress further. In accordance with some embodiments, this result can be reported at operation 59. The camera system may then exit the dust removal mode at operation 60 and end the dust removal process.

On the other hand, and if a particle is detected or if the particle detection portion of the process was skipped, a control signal can be sent to the MEMS stage in order to begin driving the image sensor and/or MEMS stage towards the bumper(s) at operation 55 for some specified amount of time. As discussed previously, the duration of time during which the image sensor and/or MEMS stage is made to impact bumpers can be variable and may be controlled. At operation 56, it can be determined whether or not the specified amount of time during which impact dust removal is to occur has elapsed. If so, at operation 57, the impact(s) are stopped. In accordance with some embodiments, there may be a certain number of rounds of such impact operations that are induced. In this case, at operation 58, it is determined if the specified number of rounds of impact actions have been reached. Like the duration of impact actions, the number of rounds of impact actions can be varied/controlled as desired or as necessary. For example, there can be some set number of rounds. It should be noted that the speed at which the image sensor is moved can also be varied and/or controlled if desired. For example, if after some threshold number of vibratory actions has been applied and the particle remains, faster accelerative force(s) may be induced resulting in greater force when hitting a bumper stop. Alternatively, checking for the presence of dust (at operation 53) can be repeated until no dust is found. If the specified number of impact rounds has not yet been reached, another round of impacts are initiated. If the specified number of rounds has been reached, the process can report the results at operation 59, and the camera system can exit the dust removal mode at operation 60, thereby ending the dust removal process.

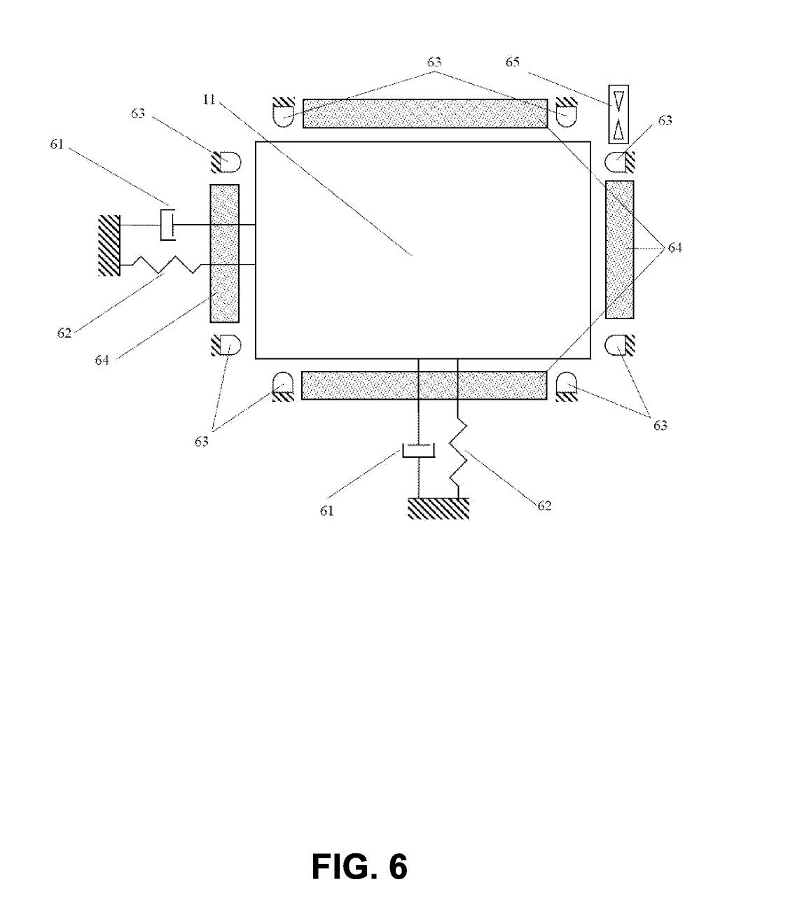

FIG. 6 is a schematic representation of an image sensor sub-module in a camera system with a dust removal mechanism in accordance with various embodiments of the technology disclosed herein. The image sensor sub-module may include: an image sensor, e.g., image sensor 11; MEMS actuators 61 driving the image sensor 11 in both image sensor plane directions; MEMS motion control springs 62 that control the motion of image sensor 11; one or more bumpers 63 positioned in both horizontal and vertical directions to serve as impact stops; and one or more particle getters/collectors 64 that capture and/or immobilize dust particles once they reach the collectors 64. It should be noted that collectors 64 can be made of sticky or otherwise adhesive materials such as, but not limited to, epoxy, silicone or urethane, or electrodes that can form an electrostatic field, or a trapped charge in an insulator.

MEMS actuators 61 and motion control springs 62 can vibrate the image sensor 11 with a pre-designed vibration waveform, such as, but not limited to, sinusoidal functions and random functions, or drive the image sensor 11 toward the bumpers 63 to cause impacts. The vibrations and/or impacts caused by MEMS actuators 61 and controlled by motion control springs 62 may remove dust particles from a pixel array area of the image sensor 11. It should be noted that as described herein, although the aforementioned vibration and impact dust removal mechanisms/methods are discussed as separate embodiments, they may be combined or considered one in the same. For example, vibrational movement can be utilized as accelerate image sensor 11 alone or as a method of acceleration towards one or more bumpers. Alternatively, and as previously discussed, impact dust removal can be achieved via accelerating image sensor 11 towards one or more bumpers, but not necessarily through the use of vibration, but rather, e.g., through more “singular” accelerative movements. Dust particles can be immobilized by the one or more collectors 64. The more dust particles are immobilized by the collectors 64, the less the possibility exists that a dust particle reaches the pixel array area of the image sensor 11 and degrade the image quality.

In addition, an air ionizer 65 can be added to the image sensor sub-module, which may be constructed by, e, g., sharp tips and a voltage supply. When a high enough voltage is applied to the sharp tips of air deionizer 65, the air around the sharp tips may become ionized. In one embodiment, the air ionizer 65 is integrated with MEMS actuators 61 and MEMS motion control springs 62 on a single chip. The free moving ions can neutralize the electrostatic charges on image sensor 11 surface, and hence reduce the electrostatic force that may be resulting in the attachment of the dust particles to the surface of image sensor 11. This reduction in electrostatic force can aide in making it easier to shake dust particles off the image sensor 11.

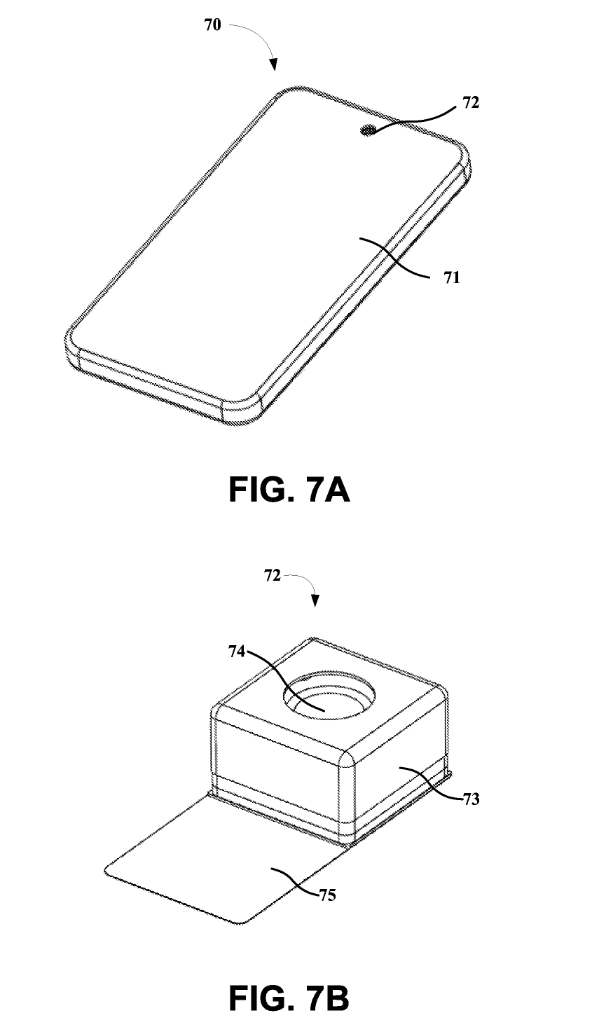

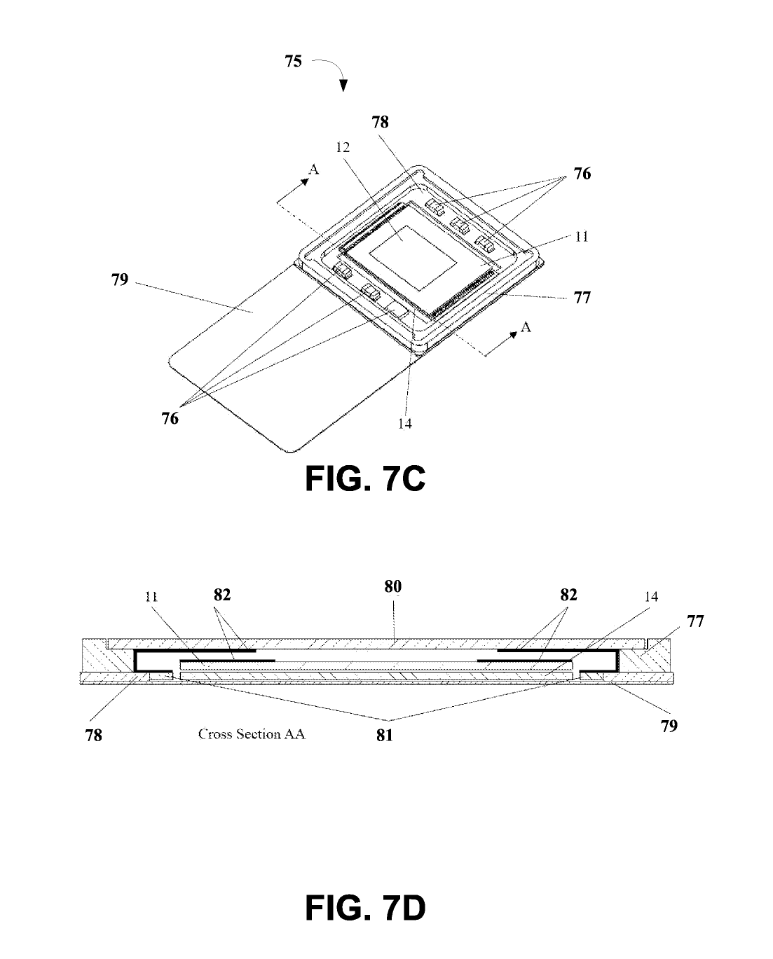

FIGS. 7A and 7B illustrate an example device and camera module in which a MEMS based dust removal mechanism for an image sensor can be implemented in accordance with various embodiments. As previously discussed, the device may include, but is not limited to, a cellphone, smart phone, PDA, tablet computer, etc. in accordance with various embodiments of the technology disclosed herein. In particular, FIG. 7A is a perspective view of an example mobile device 70, such as a smart phone, with a miniature digital camera module integrated therein. Mobile device 70 may be comprised of a body 71 that contains all the components and modules for its various functionalities, which may include a miniature camera 72 module installed therein.

FIG. 7B illustrates a perspective view of an example camera module 72. Camera module 72 can include an electromagnetic interference shield 73, a lens barrel 74 for handling optical image formation, and an image sensor sub-module 75, such as that illustrated in FIG. 6.

FIG. 7C is a perspective view of the image sensor sub-module 75 of FIG. 7B.

The image sensor sub-module 75 can include an image sensor 11 that is mounted on a MEMS stage 14, electronic components 76 that are part of a driving circuit, an image sensor housing 77 that enclose the image sensor 11 and MEMS stage 14, a circuit board 78 that contains part of the driving circuit and holds MEMS stage 14, a back plate 79, and an infrared cut filter 80 (not shown in FIG. 7C) that covers image sensor 11 and filters out the infrared component of incoming light.

FIG. 7D is a cross-sectional view of image sensor sub-module 75. In particular, this cross-sectional view is representative of a cross-section of image sensor sub-module 75 along the dashed line shown in FIG. 7C and viewed along the direction AA. As illustrated in FIG. 7D, back plate 79 is attached to the bottom of circuit board 78 and may be a flex circuit, a thermal heat sink film, a stiffener, or any combination thereof. The image sensor housing 77 is attached to the top of the circuit board 78, and infrared cut filter 80 mounted on the image sensor housing 77 forms an enclosure for the image sensor 11 mounted on MEMS stage 14. Impact bumpers 81 may be part of the circuit board 78, the image sensor housing 77 or the MEMS stage 14, or they may be separate components that are attached to the circuit board 78 or image sensor housing 77. Particle collectors 82 can be located on any surface that is not required to be free of particles. For example, the particle collectors 82 may be on the surface of the image sensor 11 around the pixel array area 12, on the surface of the circuit board 78, on the inside of the image sensor housing 77, or on the inside of the infrared cut filter 80. The particle collectors 82, as described above, may be made of various materials and/or components used to immobilize contaminant particles. It should be noted that although particle collectors are described and illustrated herein in the context of the impact dust removal embodiments, particle collectors may also be used to collect particles freed from the image sensor using vibration dust removal. It should be further noted that the various embodiments disclosed herein are not necessarily exclusive. For example, a camera system may employ both vibrational dust removal as well as impact dust removal.

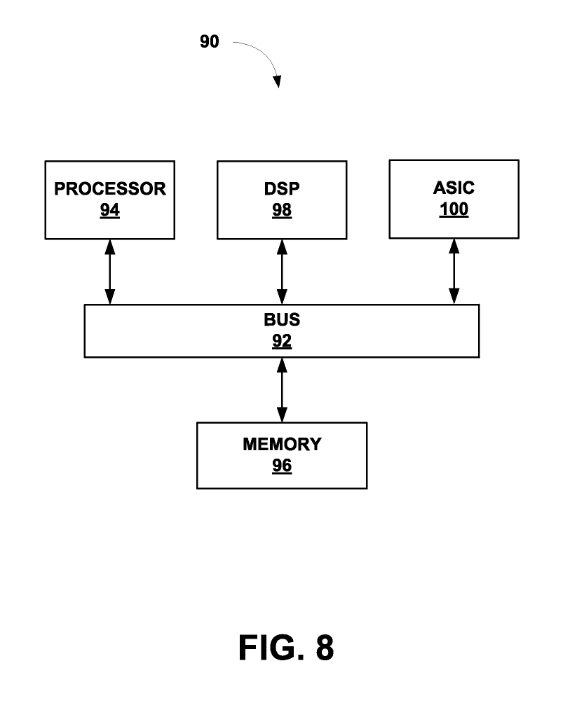

FIG. 8 illustrates a chip set/computing module 90 in which embodiments of the technology disclosed herein may be implemented, such as control of the aforementioned dust removal processes. Chip set 90 can include, for instance, processor, memory, and additional image components incorporated in one or more physical packages. By way of example, a physical package includes an arrangement of one or more materials, components, and/or wires on a structural assembly (e.g., a baseboard) to provide one or more characteristics such as physical strength, conservation of size, and/or limitation of electrical interaction.

In one embodiment, chip set 90 includes a communication mechanism such as a bus 92 for passing information among the components of the chip set 90. A processor 94, such as an image processor has connectivity to bus 92 to execute instructions and process information stored in a memory 96. A processor may include one or more processing cores with each core configured to perform independently. Alternatively or in addition, a processor may include one or more microprocessors configured in tandem via bus 92 to enable independent execution of instructions, pipelining, and multithreading. Processor 94 may also be accompanied with one or more specialized components to perform certain processing functions and tasks such as one or more digital signal processors, e.g., DSP 98, and/or one or more application-specific integrated circuits (IC) (ASIC) 100, such as that which can be utilized to, e.g., drive a MEMS actuator for achieving dust removal functionality. DSP 98 can typically be configured to process real-world signals (e.g., sound) in real time independently of processor 94. Similarly, ASIC 100 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The aforementioned components have connectivity to memory 96 via bus 92. Memory 96 includes both dynamic memory (e.g., RAM) and static memory (e.g., ROM) for storing executable instructions that, when executed by processor 94, DSP 98, and/or ASIC 100, perform the process of example embodiments as described herein. Memory 96 also stores the data associated with or generated by the execution of the process.

As used herein, the term module might describe a given unit of functionality that can be performed in accordance with one or more embodiments of the present application. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the application are implemented in whole or in part using software, in one embodiment, these software elements can be implemented to operate with a computing or processing module capable of carrying out the functionality described with respect thereto. One such example computing module is shown in FIG. 10. Various embodiments are described in terms of this example-computing module 90. After reading this description, it will become apparent to a person skilled in the relevant art how to implement the application using other computing modules or architectures.

In this document, the terms “computer program medium” and “computer usable medium” are used to generally refer to transitory or non-transitory media such as, for example, memory 96, or other memory/storage units. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 90 to perform features or functions of the present application as discussed herein.

While various embodiments of the disclosed method and apparatus have been described above, it should be understood that they have been presented by way of example only, and not of limitation. Likewise, the various diagrams may depict an example architectural or other configuration for the disclosed method and apparatus, which is done to aid in understanding the features and functionality that can be included in the disclosed method and apparatus. The disclosed method and apparatus is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the disclosed method and apparatus. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed method and apparatus is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosed method and apparatus, whether or not such embodiments are described and whether or not such features are presented as being a part of a described embodiment. Thus, the breadth and scope of the claimed invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosed method and apparatus may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A device, comprising:
a component sensitive to contaminants;
a stage upon which the image sensor is mounted; and
one or more actuators for imparting movement on the stage to remove one or more contaminants residing on the image sensor.

2. The device of claim 1, wherein the stage comprises a microelectromechanical (MEMS) stage and the one or more actuators comprise MEMS actuators.

3. The device of claim 1, wherein the one or more actuators drive the stage by imparting vibrational movement to the stage.

4. The device of claim 1, wherein the component comprises an image sensor.

5. The device of claim 1, wherein the device comprises a miniature digital camera system.

6. The device of claim 1, wherein the one or more actuators induce movement of the stage towards one or more impact stops, such that hitting the one or more impact stop results in the removal of the one or more contaminants.

7. The device of claim 1, further comprising a contaminant collector for collecting the one more contaminants upon being removed from the image sensor.

8. The device of claim 1, further comprising an air ionizer to neutralize electrostatic charge on a surface of the component.

9. The device of claim 1, further comprising one or more motion control springs that control movement of the stage and operate in conjunction with the one or more actuators to impart the movement to the stage.

10. A method, comprising:
inducing movement of a contaminant-sensitive component for at least one of a specified duration and a specified number of movements for removing one or more contaminants are present on the contaminant-sensitive component; and
upon reaching the at least one of the specified duration and the specified number of movements, ceasing inducing the movement of the contaminant-sensitive component.

11. The method of claim 10, wherein the inducing of the movement comprises inducing vibrational motion to shake the one or more contaminants free from a surface of the contaminant-sensitive component.

12. The method of claim 11, wherein the vibration motion is effectuated by at least one of a sinusoidal function or a random function.

13. The method of claim 10, wherein the inducing of the movement comprises inducing movement of the contaminant-sensitive component such that the contaminant-sensitive component accelerates towards one or more stop elements, contacting of the one or more stop elements by the contaminant-sensitive component resulting in shaking the one or more contaminants from a surface of the contaminant-sensitive component.

14. The method of claim 10, further comprising capturing the one or more contaminants upon removal from the contaminant-sensitive component via a collector.

15. The method of claim 10, wherein prior to the inducing of the movement, a determination is made to ascertain whether or not contaminants are present on the contaminant-sensitive component.

16. A camera system, comprising:
an image sensor; and
a microelectromechanical (MEMS) stage on which the image sensor is mounted, the MEMS stage engaging in movement to remove one or more contaminants present on the image sensor.

17. The camera system of claim 16, wherein the movement of the MEMS stage comprises vibrational movement.

18. The camera system of claim 16, wherein the movement of the MEMS stage comprises movement towards one or more impact stops.

19. The camera system of claim 16, wherein the movement of the MEMS stage is effectuated via one or more MEMS actuators and one or more motion control springs.

20. The camera system of claim 16, further comprising contaminant collectors for capturing the one or more contaminants upon removal from the image sensor.
